(19) United States
(12) Patent Application Publication
(10) Pub. No.: US 2023/0213404 A1
(43) Pub. Date: Jul. 6, 2023

(54) MACHINE FOR BALANCING THE WHEELS OF A VEHICLE

(71) Applicant: Sicam S.r.l., Correggio (Reagio Emilia) (IT)

(72) Inventor: Marco Montanari, Correggio (Reagio Emilia} (IT)

(21) Appl. No.: 17/927,836

(22) PCT Filed: May 20, 2021
(86) PCT No.: PCT/IB2021/054378

§ 371 Date: Nov. 25, 2022

(30) Foreign Application Priority Data
May 25, 2020 (IT) 102020000012232

(51) Int. Cl. G01M 1/02; G01M 1/16

(52) U.S. Cl. CPC G01M 1/02; G01M 1/16

(57) ABSTRACT

The machine for balancing the wheels of a vehicle includes a supporting frame provided with a rotating shaft adapted to support and set a wheel (R) to be balanced in rotation; detection means for detecting the unbalance of the wheel (R); identification means for identifying at least one portion of the wheel (R) for the measurement of characteristic parameters, which includes an emitter of laser radiation along an optical emission path lying at least partly on a predefined plane of emission (X-Y); and a detector to receive the laser radiation and arranged along an optical receiving path; reflection means adapted to deflect the optical emission path and the optical receiving path, the optical emission path being substantially coincident with the optical receiving path.

### TECHNICAL FIELD

The present invention relates to a machine for balancing the wheels of a vehicle.

### BACKGROUND ART

As is well known, the wheels of a vehicle can have unbalances, caused, for example, by tire wear, which can cause damage to the wheel itself and to the vehicle as a result, e.g., of abnormal vibrations on the mechanical parts or irregular tire wear.

In detail, there are two main types of unbalance: dynamic, or also called torque, and static. Static unbalance occurs when the wheel's center of gravity is not on the axis of rotation, but is parallel to the axis of inertia, while dynamic unbalance occurs when the axis of rotation is inclined by an angle to the axis of inertia.

It is therefore necessary to perform periodic balancing operations of a wheel, which consist in applying counterweights, made of lead for example, to offset any irregularities in the tire and/or rim.

Usually, wheel balancing is carried out using a wheel balancing machine in which the wheel is set in rotation by a drive shaft so that the centrifugal forces generated by the unbalance are made manifest.

These centrifugal forces can be measured by means of special detection means, which usually consists of load cells or other piezoelectric transducers placed at the point where the drive shaft supports are located.

More specifically, the unbalance of the wheel, in particular static unbalance, can be measured by identifying at least one balancing plane orthogonal to the axis of the relevant wheel. Dynamic unbalance, on the other hand, can be measured by identifying two balancing planes at a distance from each other along the axis of the wheel.

In order to identify the balancing planes and measure the wheel unbalance, it is necessary to acquire the wheel profile and measure some characteristic geometric parameters, such as the diameter at the balancing plane and the distance of the latter from a fixed reference point. This information is then sent to a data processing unit, which calculates the weight of the counterweights to be fitted to the wheel and the position where the operator will have to fit them to achieve wheel balancing.

Usually, positioning is done by the wheel balancing machine using special laser pointers to indicate the portion where the operator will have to fit the counterweights in order to balance the wheel. In some cases, the laser pointers are fixed to the frame and the light beam can be reflected by an oscillating mirror that deflects this beam in such a way as to move it along a circular sector inside the rim to indicate the point where the counterweights have to be fitted. With regard, on the other hand, to the acquisition of the wheel profile, a first solution is the use of contact measuring sensors, such as e.g. a mechanical probe, connected to an electronic measuring system which detects the position of the probe with respect to a predefined reference system and sends the detected information to the data processing unit.

However, mechanical probes are very cumbersome and inaccurate in acquiring the wheel profile.

An alternative solution is the use of laser sensors by means of which the external profile of the wheel can be scanned. Usually, such sensors are mounted on straight and/or rotating rails which permit directing the emitted laser light along the wheel profile.

However, these solutions have a number of drawbacks linked to the fact that the movement of the sensor requires complex apparatus which are inconvenient to make and very expensive.

Furthermore, the complexity of these apparatuses makes maintenance operations difficult and impractical.

### SUMMARY OF THE INVENTION

The main aim of the present invention is to devise a balancing machine which is easy to manufacture and has a lower cost than known machines provided with a laser scanning system.

One object of the present invention is to devise a balancing machine in which the sensor intended for the profile acquisition is arranged according to a predefined positioning so that the acquisition of the wheel profile is perfected and not affected by refraction/reflection phenomena.

Therefore, the present invention relates to a balancing machine according to claim 1, having structural and functional characteristics such as to satisfy the aforesaid requirements and at the same time to overcome the drawbacks mentioned above with reference to the prior art.

### BRIEF DESCRIPTION OF THE DRAWINGS

Other characteristics and advantages of the present invention will become more apparent from the description of a preferred, but not exclusive, embodiment of a balancing machine, illustrated by way of an indicative, yet non-limiting example, in the accompanying tables of drawings in which:

FIG. 1 is a perspective view of the balancing machine according to the present invention;

FIG. 2 is a detailed view of the identification means and of the reflection means of the machine of FIG. 1;

FIGS. 3 and 4 are side views of the machine of FIG. 1; and

FIG. 5 is a detailed view from above of the identification means and of the reflection means of the machine of FIG. 1.

### DETAILED DESCRIPTION

With particular reference to such figures, reference numeral 1 globally indicates a machine for balancing the wheels of a vehicle by means of offset masses.

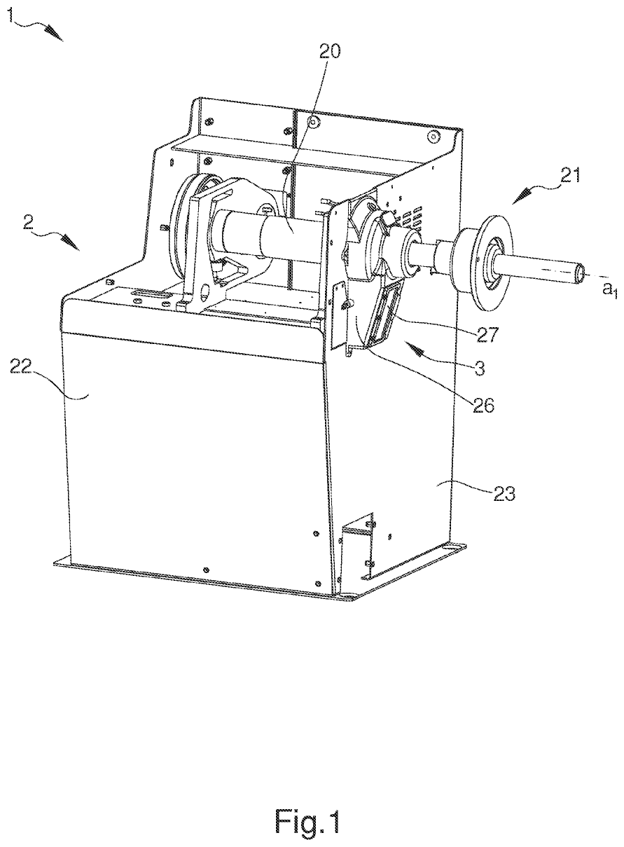

As shown in FIG. 1, the machine 1 comprises a supporting frame 2 provided with a rotating shaft 20 adapted to support and set a wheel R to be balanced in rotation around a relevant axis of rotation a1.

For this purpose, the frame 2 supports an actuator, not shown in the figures, adapted to set the shaft 20 in rotation. The shaft 20 is provided with fixing means 21 to keep the wheel R in a coaxial position during rotation.

By wheel R is meant the set comprising a rim C and a tire P mounted on the rim C itself The rim C is provided with a central hole for coupling to the parts of the vehicle and through which the shaft 20 is inserted. In particular, the rim C is fitted over the shaft 20 through the hole and is locked in position with respect to the shaft 20 itself by means of the fixing means 21.

The frame 2 comprises a main body 22 in which a substantially vertical side wall 23 is identified from which the shaft 20 protrudes cantilevered. Preferably, the shaft 20 extends axially along a direction, in use, substantially horizontal and parallel to the axis of rotation a1.

In the context of the present disclosure, the terms “upper”, “lower”, “vertical” and “horizontal”, used with reference to the machine 1, must be deemed to refer to the conditions of normal use of the machine 1, i.e. those wherein it is used by a user and is arranged resting on the ground.

The machine 1 comprises detection means for detecting the unbalance of the wheel R, which are mounted on the frame 2 and allow measuring the centrifugal forces operating on the shaft 20 when the latter is set in rotation together with the wheel R.

The unbalance detection means are not shown in detail in the figures as they are of known type.

For example, the unbalance detection means consist of measuring means, such as force transducers, load cells or other piezoelectric transducers, interposed between the frame 2 and the shaft 20.

The machine 1 also comprises identification means 3 for identifying at least one portion of the wheel R for the measurement of characteristic parameters.

The identification means 3 are mounted on the frame 2 and provided with an optical sensor of the combined emitter/detector type. In particular, the identification means 3 comprise an emitter 30 of laser radiation 31 along an optical emission path 32 lying at least partly on a predefined plane of emission X-Y, and a detector 34 to receive the laser radiation 31 and arranged along an optical receiving path 35.

Conveniently, the identification means 3 are configured to identify at least one of:
a balancing plane;
a radial eccentricity of the wheel R;
a lateral eccentricity of the wheel R;
a number of spokes of the wheel R;
a position of spokes of the wheel R.

In particular, the emitter 30 and the detector 34 are configured to scan the profile of the wheel R and to identify at least one balancing plane arranged substantially orthogonal to the axis of rotation a1 of the wheel R.

In the event of dynamic balancing having to be carried out, the identification means 3 are configured to identify at least two balancing planes spaced apart from each other along the axis of rotation a1 of the wheel.

Alternatively, or in combination with the function of identifying the balancing plane(s), the emitter 30 and the detector 34 may be used to measure the radial and/or lateral eccentricity of the wheel R.

Alternatively, or in combination with the function of identifying the balancing plane(s), furthermore, the emitter 30 and the detector 34 may also be used to identify the number and position of any spokes of the rim C, if the wheel R is provided with an alloy rim.

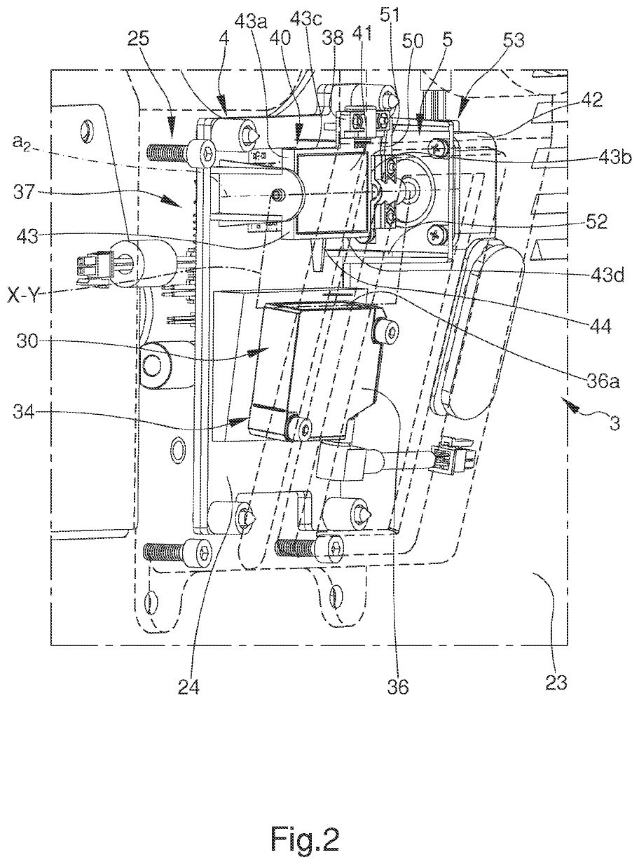

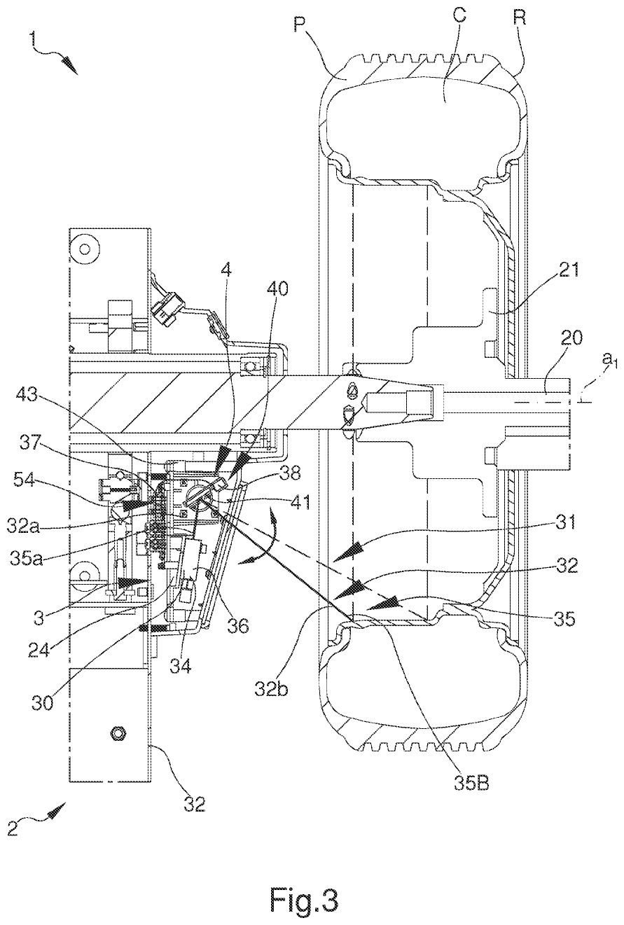

As shown in FIG. 2, the emitter 30 and the detector 34 are accommodated inside a same enclosure 36 mounted fixed on the frame 2. In particular, the enclosure 36 is mounted on the side wall 23 of the frame 2, preferably below the shaft 20.

The enclosure 36 comprises a transparent surface 36a through which the laser radiation 31 enters and/or exits into/from the detector 34/emitter 30, respectively.

Conveniently, the laser radiation 31 emitted by the emitter 30 is linearly collimated, that is, at the projection point the laser radiation 31 extends linearly by a stretch of predetermined length. Linear emitters of laser radiation 31 turn out to be easy to manufacture and inexpensive, thus significantly reducing the overall cost of the machine 1.

The detection means and the identification means 3 are connected to a processing unit adapted to process the information provided by the detection means and the identification means 3 to calculate the weight of the offset masses to be applied along the profile of the wheel R and to determine the angular position along the profile itself where the weights must be fitted to carry out balancing. The processing unit identifies at least one point of application of the offset masses along the profile of the wheel R. The points of application of the offset masses may also be more than one and, in a particular embodiment, their position may be preset by the user.

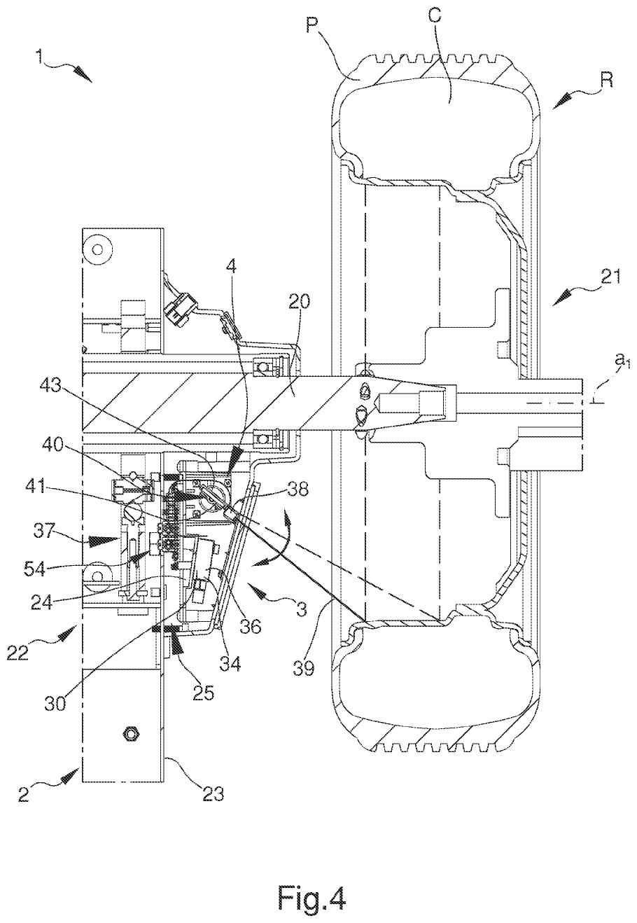

Conveniently, the machine 1 comprises at least one circuit board 37 on which the processing unit and substantially all the electronic components are arranged. With reference to the example in FIG. 4, the machine 1 comprises at least one optical device 38 adapted to emit a light beam 39 which identifies a light point on the surface of the rim C of the wheel R, where the light point is adapted to identify a fixed reference position with respect to the machine 1 itself and at which the operator wishes to apply the offset masses for offsetting the unbalance of the wheel R. In actual facts, after that the points of application of the offset masses have been set, the optical device 38 emits a light beam 39, preferably of the laser type, towards the wheel R by identifying the points of application to facilitate the user in applying the offset masses. For this purpose, the optical device 38 is connected to the processing unit via manifolds. The operation of the optical device 38 will be described in detail throughout the present description.

Conveniently, the optical device 38 is separated from the identification means 3 and the light beam 39 emitted by the optical device 38 being collimated punctually, i.e. the light beam 39 at the projection point is substantially point like.

Advantageously, the machine 1 comprises reflection means 4 adapted to deflect the optical emission path 32 and the optical receiving path 35. In this way, by means of the reflection means 4, the laser radiation 31 can be directed to different areas of the wheel R while keeping the emitter 30 and the detector 34 in a substantially fixed position. Conveniently, the optical emission path 32 substantially coincides with the optical receiving path 35. This characteristic reduces possible reflection and/or refraction phenomena making the scan of the wheel profile more precise.

In detail, the reflection means 4 are arranged along the optical emission path 32 and optical receiving path 35 so that, in use, the laser radiation 31 is deflected towards the wheel R to be balanced irrespective of the installation position of the identification means 3. Preferably, the reflection means 4 are mounted on the side wall 23 of the frame 2, in particular they are mounted above the enclosure 36 so that they intercept the optical emission path 32 and optical receiving path 35.

Alternative configurations cannot however be ruled out, for example configurations wherein the emitter 30 and the reflection means 4 are arranged above the shaft 20 and the laser radiation 31 is emitted downwards.

As shown in FIG. 1, preferably, the reflection means 4 and the identification means 3 are housed inside a protective cover 26. Conveniently, the protective cover 26 comprises at least one transparent wall 27 for the transit of the laser radiation 31 reflected by the reflection means 4. In other words, the transparent wall 27 allows the optical emission path 32 and the optical receiving path 35 to enter and exit into/from the protective cover 26, respectively.

In order to direct the laser radiation 31 towards different areas of the wheel R, the reflection means 4 comprise at least one reflecting element 40 provided with a substantially flat reflecting surface 41, the reflecting element 40 rotating around its own axis of rotation a2 orthogonal to the axis of rotation a1 of the wheel R. In particular, the reflecting element 40 rotates to deflect the laser radiation 31 towards different points on the wheel R so that the profile can be scanned.

Being arranged below the shaft 20, the reflecting element 40 directs the laser radiation 31 towards the portion of the wheel R arranged below the shaft 20. The complete scanning of the profile of the wheel R is then carried out by the rotation of the wheel R itself.

Preferably, the reflecting element 40 is a mirror and has a substantially rectangular shape.

Preferably, the reflecting element 40 is centered, i.e. the axis of rotation a2 of the reflecting element 40 passes through the center of gravity of the latter and is parallel to its length.

The reflecting element 40 is configured to deflect the laser radiation 31 along the optical emission path 32 and the optical receiving path 35. In actual facts, the optical emission path 32 comprises a first stretch 32a extending between the emitter 30 and the reflecting element 40 and a second stretch 32b extending between the reflecting element 40 and the wheel R. Similarly, the optical receiving path 35 comprising a first stretch 35a extending between the detector 34 and the reflecting element 40 and a second stretch 35b extending between the reflecting element 40 and the wheel R. In particular, the first stretches 32a, 35a of the optical emission path 32 and the optical receiving path 35 are substantially fixed, while the second stretches 32b, 35b, by means of the rotation of the reflecting element 40, vary the angular direction thereof.

Conveniently, the first stretches 32a, 35a of the optical emission path 32 and of the optical receiving path 35 lie on the plane of emission X-Y. In detail, the reflecting element 40, by rotating around its axis of rotation a2, moves the second stretches 32b, 35b along a circular sector. The angular position of the reflection means 4 with respect to the emitter 30, and thus with respect to the plane of emission X-Y, is adjustable to change the direction of the second stretches 32b, 35b.

For this purpose, the reflection means 4 comprise an actuator 42 adapted to rotate the reflecting element 40 around its axis of rotation a2. The actuator 42 is connected to the processing unit, the latter being configured to actuate and control the actuator 42. Conveniently, the identification means 3 are provided with an angular position transducer connected to the processing unit configured to convert the angular position of the reflecting element 40 into a signal transmitted to the processing unit.

Advantageously, the axis of rotation a2 of the reflecting element 40 is substantially parallel to the plane of emission X-Y of the emitter 30 and substantially perpendicular to the direction of emission of the laser radiation 31. This way, the synergistic combination of the relative positions between the emitter 30, the detector 34 and the reflection means 4 allows the optical receiving path 35 to substantially coincide with the optical emission path 32, thus reducing the refraction and/or reflection phenomena during scanning of the profile of the wheel R.

In a preferred embodiment, the axis of rotation a2 of the reflecting element 40 lies on the plane of emission X-Y, making the optical emission path 32 and the optical receiving path 35 more symmetrical with each other, and thus making the scanning of the profile of the wheel R more precise.

In one version, the plane of emission X-Y is inclined with respect to the axis of rotation a1 of the wheel R to increase the angular scanning range of the profile of the wheel.

As can be seen from FIG. 2, the reflecting element 40 of the reflection means 4 is mounted in a frame 43, the latter being fixed rotating to a supporting panel 24 to rotate around the axis of rotation a2 of the reflecting element 40. The supporting panel 24 is mounted on the side wall 23 of the frame 2. Conveniently, the supporting panel 24 is spaced apart from the side wall 23 to define a gap 25 adapted to house the circuit board 37.

Conveniently, the optical device 38 is mounted on the frame 43 so that the latter, by rotating, directs the light beam 39 emitted by the optical device 38 along the wheel R to identify the points of application of the offset masses. This way, by means of a single actuator 42, it is possible to control both the identification means 3 and the optical device 38, thus reducing the electronic components required for the operation of the machine 1 and, consequently, the costs of the manufacture of the same.

In detail, as shown in FIG. 4, the processing unit controls the actuator 42 to rotate the frame 43 so as to direct the light beam 39 emitted by the optical device 38 towards the position of application of the offset masses which is predetermined by means of the identification means 3.

Conveniently, the frame 43 comprises a spike 44 projecting perpendicular to the axis of rotation a2 of the reflecting element 40, the usefulness and operation of which will be described in the remainder of the present description.

In a preferred embodiment, the frame 43 has a substantially rectangular shape wherein a first edge 43a and a second opposite edge 43b can be identified which are arranged perpendicular to the axis of rotation a2, as well as a third edge 43c and fourth opposite edge 43d which are arranged parallel to the axis of rotation a2 of the reflecting element 40. Preferably, the optical device 38 and the spike 44 are arranged opposite each other. In particular, the optical device 38 is mounted on one of either the third edge 43c or the fourth edge 43d of the frame 43, while the spike 44 is mounted on the other of either the third edge 43c or the fourth edge 43d.

Conveniently, the spike 44 and the frame 43 are made in a single monolithic body, preferably by means of a 3D printer. In particular, the spike 44 is arranged on the same plane as the reflecting element 40 thus making the manufacture of the frame 43 by means of the 3D printer easy and inexpensive, thereby reducing the production costs of the machine 1.

Conveniently, the frame 43 comprises at least one limit switch 5 configured to limit the rotation of the frame 43 itself to a maximum amplitude of less than 360°. Preferably, the maximum rotation range of the frame is 180°. This way, it is possible to prevent the manifolds of the optical device 38 from becoming tangled during the rotation of the reflecting element 40. In detail, the limit switch 5 limits the rotation of the frame 43 between a first limit position and a second limit position, the frame 43 passing between the limit positions by a rotation of 180°.

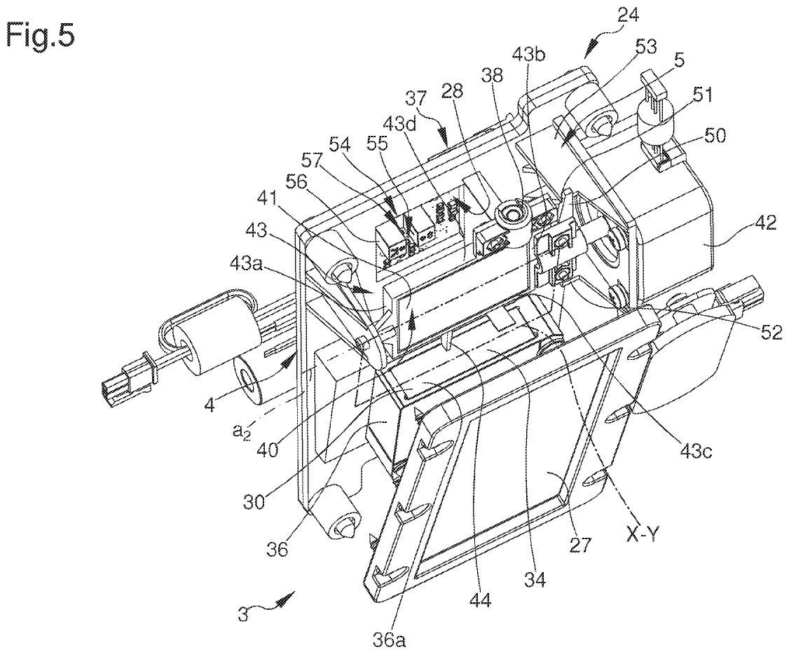

As can be seen in FIG. 5, the limit switch 5 comprises at least one stop element 50 locked together with the frame 43 and configured to engage in abutment with at least one abutment surface 51, 52 of a block element 53 to stop the rotation of the frame 43. In particular, the stop element 50 is adapted to rotate together with the frame 43 while the block element 53 is fixed to the supporting panel 24.

Preferably, the stop element 50 has a substantially linear shape and is arranged on one of either the first edge 43a or the second edge 43b of the frame 43 and extends substantially perpendicular to the axis of rotation a2 of the reflecting element 40.

In a preferred embodiment, the abutment surfaces 51, 52 are two in number, upper and lower respectively, and are arranged in an opposite position with respect to the axis of rotation a2, above and below, respectively, the axis of rotation a2 of the reflecting element 40. In detail, the abutment surfaces 51, 52 are arranged aligned with each other on a plane substantially parallel to the plane of emission X-Y, and the axis of rotation a2 is interposed between them. The stop element 50, by abutting against the upper abutment surface 51 stops the rotation of the frame 43 in the first limit position and by abutting against the lower abutment surface 52 stops the rotation of the frame 43 in the second limit position.

In the first limit position, the reflecting element 40 is arranged on a plane parallel to the plane of emission X-Y, the reflecting surface 41 is facing, in use, the wheel R, and the spike 44 and the optical device 38 are facing the emitter 30 and the shaft 20, respectively.

In the second limit position, the reflecting element 40 is arranged on a plane parallel to the plane of emission X-Y, the reflecting surface 41 is facing the side wall 23 of the frame 2, and the spike 44 and the optical device 38 are facing the shaft 20 and the emitter 30, respectively.

In order to switch from the first limit position to the second limit position, the frame 43 rotates, preferably, clockwise so that the optical device 38, during the rotation thereof, is facing the wheel R and the spike 44 is facing the circuit board 37.

In detail, the term “clockwise direction” means the direction of rotation imposed on the reflecting element 40 to move from the first limit position to the second limit position. At the same time, the term “counterclockwise direction” means the direction of rotation imposed on the reflecting element 40 to move from the second limit position to the first limit position.

Conveniently, the machine I comprises sensor means 54 configured to identify the angular position of the reflecting element 40 and of the optical device 38 by means of an initialization process of the machine 1. In detail, when the machine 1 is switched off, the reflecting element 40 may be in any position comprised between the first and second limit positions. Subsequent to the switching on of the machine 1, the initialization process allows the frame 43 to be arranged in an initial position wherein, preferably, the frame 43 is rotated by 90° degrees with respect to the first limit position.

For this purpose, the sensor means 54 comprise at least one photoelectric sensor 55 configured to detect the transit of the spike 44 from a predetermined position by generating an electrical signal sent to the processing unit. In particular, the photoelectric sensor 55 is configured to detect when the reflecting element 40 is arranged in the initial position.

For this purpose, the photoelectric sensor 55 comprises a fork element 56 having a slit 57 configured for the transit of the spike 44 during rotation of the frame 43. The photoelectric sensor 55 also comprises a photocell arranged in the slit 57 and adapted to generate an electrical signal upon the transit of the spike 44.

As shown in FIG. 5, the fork element 56 is mounted on the circuit board 37 and the supporting panel 24 comprises an opening 28 wherein the fork element 56 is at least partly inserted to arrange the slit 57 in the proximity of the frame 43 so that, when the frame 43 is in the predetermined initial position, the spike 44 is arranged in the slit 57 of the fork element 56.

The sensor means 54 also comprise a photoelectric transducer configured to detect when the frame 43 is arranged in the second limit position. In particular, the photoelectric transducer is of the emitter/receiver type and emits a light radiation towards the frame 43; when the latter is in the second limit position, the reflecting surface 41 of the reflecting element 40 mirrors the light radiation back towards the photoelectric transducer. At this point, the photoelectric transducer receives the reflected light radiation and consequently generates an electrical signal sent to the processing unit to signal that the frame 43 is in the second limit position.

The initialization process comprises a first phase wherein the reflecting element 40 is made to rotate, preferably clockwise, until one of either the photocell or the photoelectric transducer generates an electrical signal: that is, until the frame 43 is arranged either in the initial position, wherein the spike 44 passes through the slit 57 of the photoelectric sensor 55, or in the second limit position, wherein the photoelectric transducer is mirrored in the reflecting surface 41. In detail, before the machine 1 is switched on, the reflecting element 40 may be in an angular position between the initial position and the second limit position. In this case, since the frame 43 is made to rotate clockwise, the spike 44 does not intercept the photocell and the reflecting element 40 reaches the photoelectric transducer which generates an electrical signal sent to the processing unit. Subsequently, the reflecting element 40 is made to rotate counterclockwise so that it can reach its initial position.

In another situation, prior to switching on, the reflecting element 40 may be in a position between the first limit position and the initial position. By turning the spike 44 clockwise, this passes through the slit 57 and reaches the initial position.

It has in fact been ascertained how the described invention achieves the intended objects, and in particular the fact is underlined that by means of the wheel balancing machine it is possible to acquire the profile of the wheel in an upgraded way and with limited refraction and/or reflection phenomena.

1. A machine for balancing the wheels of a vehicle, comprising;
a supporting frame provided with a rotating shaft adapted to support and set a wheel to be balanced in rotation around a relevant axis of rotation;
detection means for detecting the unbalance of the wheel mounted on said frame;
identification means for identifying at least one portion of said wheel for the measurement of characteristic parameters, which are mounted on said frame and comprise:
an emitter of laser radiation along an optical emission path lying at least partly on predefined plane of emission; and
a detector to receive said laser radiation and arranged along an optical receiving path;
and further comprising:
reflection means adapted to deflect said optical emission path and said optical receiving path;
and said optical emission path is substantially coincident with said optical receiving path.

2. A machine according to claim 1, wherein said identification means is configured to identify at least one of:
a balancing plane
a radial eccentricity of said wheel;
a lateral eccentricity of said wheel;
a number of spokes of said wheel;
a position of spokes of said wheel;

3. A machine according to claim 1, wherein said reflection means comprises at least one reflecting element provided with a substantially flat reflecting surface, said reflecting element rotating around its own axis of rotation orthogonal to said axis of rotation of said wheel.

4. A machine according to claim 3, wherein said axis of rotation of said reflecting element is substantially parallel to said plane of emission of said emitter and substantially perpendicular to the direction of emission of said laser radiation.

5. A machine according to claim 4, wherein said axis of rotation of said reflecting element lies on said plane of emission.

6. A machine according to claim 1, wherein said optical emission path further comprises a first stretch extending between said reflecting element and a second stretch extending between said reflecting element and said wheel, said optical receiving path comprising a first stretch extending between said emitter and said reflecting element and a second stretch extending between said reflecting element and said wheel, wherein said first stretches of said optical emission path and said optical receiving path lie on said plane of emission.

7. A machine according to claim 1, wherein said plane of emission is inclined with respect to said axis of rotation of said wheel.

8. A machine according to claim 1, wherein said laser radiation emitted by said emitter is linearly collimated.

9. A machine according to claim 1, further comprising at least one optical device adapted to emit a light beam which identifies a light point on the surface of a rim of said wheel, where said light point is adapted to identify a fixed reference position with respect to the machine and at which offset masses for offsetting the unbalance of the wheel are applicable.

10. A machine according to claim 9, wherein said optical device is separated from said identification means and said light beam emitted by said optical device is collimated punctually.

11. A machine according to claim 1, wherein said emitter and said detector are accommodated inside a same enclosure mounted fixed on said frame.

12. A machine according to claim 9, wherein said reflection means includes a reflection element that is mounted in a second frame and said optical device is mounted on said second frame.
